(19) United States
(12) Patent Application Publication
(10) Pub. No.: US 2016/0288480 A1
(43) Pub. Date: Oct. 6, 2016

(54) PRINTING METHOD AND PRINTING APPARATUS

(71) Applicant: JUN SAKAMOTO, Osaka-shi, Osaka (JP)

(72) Inventor: Koji SAKAMOTO, Osaka (JP)

(73) Assignee: Jun SAKAMOTO, Osaka-shi. Osaka (JP)

(21) Appl. No.: 15/037,827

(22) PCT Filed: Nov. 20, 2014
(86) PCT No.: PCT/JP2014/080722

§ 371 Date: May 19, 2016

(30) Foreign Application Priority Data
Nov. 20, 2013 (JP) 2013-239732

(51) Int. Cl. B41F 3/02

(52) U.S. Cl. CPC B41F 3/02

(57) ABSTRACT

Provided are: preparing a printing apparatus including a printing plate and a transfer roll; preparing a to-be-printed object; transferring ink indicating identification information corresponding to the to-be-printed object from the printing plate to the transfer roll; and transferring the ink from the transfer roll to the tablet as a result of contact of the transfer roll with at least part of a side surface of the to-be-printed object in such a manner as to wrap around the to-be-printed object.

### TECHNICAL FIELD

The present invention relates to a printing method and a printing apparatus.

### BACKGROUND ART

Disclosed in Patent Literature 1 is a technology of recording (printing) individual identification information on a tablet. With a method described in Patent Literature 1, the individual identification information (a two-dimensional code) is printed on the tablet through inkjet printing. Reading the individual identification information makes it possible to perform unique individual identification of pharmacological products on an individual tablet basis to thereby make discrimination between fake products and proper products.

### CITATION LIST

### Patent Literature

### [Patent Literature 1]

Japanese Patent Application Laid-Open Publication No. 2008-279060

### SUMMARY OF INVENTION

### Technical Problem

However, the technology of Patent Literature 1 has faced a problem that, as a result of printing the individual identification information on the to-be-printed object (tablet) through the inkjet printing, ink printed on the to-be-printed object is blurred.

In view of the problem described above, the present invention has been made, and it is an object of the invention to provide a printing method and a printing apparatus capable of suppressing blurring of ink printed on a to-be-printed object upon the ink printing on the to-be-printed object.

### Solution to Problem

A printing method according to the invention includes: preparing a printing apparatus including a printing plate and a transfer roll; preparing a to-be-printed object; transferring ink indicating identification information corresponding to the to-be-printed object from the printing plate to the transfer roll; and transferring the ink from the transfer roll to the to-be-printed object as a result of contact of the transfer roll with at least part of a side surface of the to-be-printed object in such a manner as to wrap around the to-be-printed object.

In one embodiment, the printing apparatus further includes a conveyance section conveying the to-be-printed object, and in the transferring the ink, the transfer roll makes contact with the conveyance section.

In one embodiment, the identification information is a matrix type two-dimensional code.

In one embodiment, the transfer roll has a blanket and a core, and a thickness of the blanket is at least 10 mm and no greater than 20 mm.

In one embodiment, rubber Shore hardness of the blanket is at least 15 and no greater than 55.

In one embodiment, the to-be-printed object is a tablet.

A printing apparatus according to the invention includes: a printing plate; and a transfer roll transferring, to a to-be-printed object, ink transferred from the printing plate, wherein a pattern based on identification information indicating information corresponding to the to-be-printed object is formed on the printing plate, and upon the transfer of the ink to the to-be-printed object, the transfer roll makes contact with at least part of a side surface of the to-be-printed object in such a manner as to wrap around the to-be-printed object.

In one embodiment, the printing apparatus further includes a conveyance section conveying the to-be-printed object, wherein, in the transferring the ink, the transfer roll makes contact with the conveyance section.

In one embodiment, the identification information is a matrix type two-dimensional code.

In one embodiment, the transfer roll has a blanket and a core, and a thickness of the blanket is at least 10 mm and no greater than 20 mm.

In one embodiment, rubber Shore hardness of the blanket is at least 15 and no greater than 55.

In one embodiment, the to-be-printed object is a tablet.

### Advantageous Effects of Invention

With the printing method according to the invention, the elastically deformed transfer roll makes contact with the to-be-printed object in such a manner as to wrap around the tablet. As a result, close adhesion of the transfer roll to the to-be-printed object permits reliable ink transfer, which can therefore suppress blurring of the ink printed on the to-be-printed object.

### BRIEF DESCRIPTION OF DRAWINGS

FIG. 1 is a side view schematically showing an embodiment of a printing apparatus according to the present invention.

FIG. 2(a) is a top view schematically showing a tablet with ink printed thereon, and FIG. 2(b) is a side view schematically showing the tablet with the ink printed thereon.

FIG. 3 is a perspective view showing a mode of transferring the ink to the tablet in the printing apparatus of the present embodiment.

FIGS. 4(a) and (b) are cross-sectional views taken along line IV-IV of FIG. 3.

FIG. 5(a) is a perspective view showing a printing plate in the printing apparatus of the present embodiment, and FIG. 5(b) is a development view of the printing plate.

FIG. 6 is a flowchart showing a printing method according to the embodiment of the invention.

FIG. 7(a) is a perspective view showing a mechanism of transferring the ink to a columnar to-be-printed object in the printing apparatus of the present embodiment, and FIG. 7(b) is a schematic cross-sectional view taken along line VIIB-VIIB of FIG. 7(a).

FIG. 8(a) is a perspective view showing a mechanism of transferring the ink to a bottle-like, to-be-printed object in the printing apparatus of the present embodiment, and FIG. 8(b) is a schematic cross-sectional view taken along line VIIIB-VIIIB of FIG. 8 (a).

### DESCRIPTION OF EMBODIMENTS

Hereinafter, an embodiment of a printing method and a printing apparatus according to the present invention will be described with reference to the drawings. Note that the invention is not limited to the embodiment described below.

### [Basic Principles]

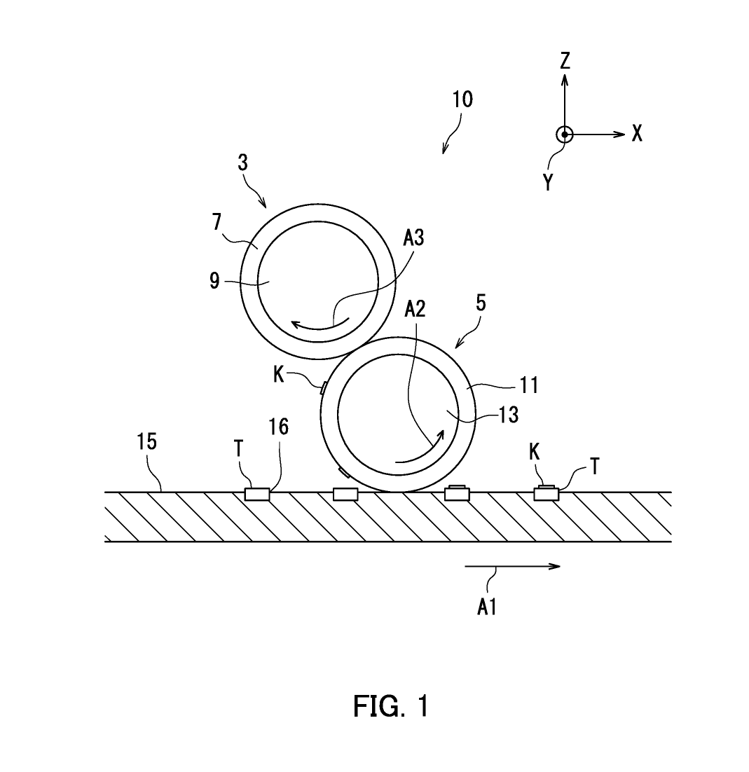

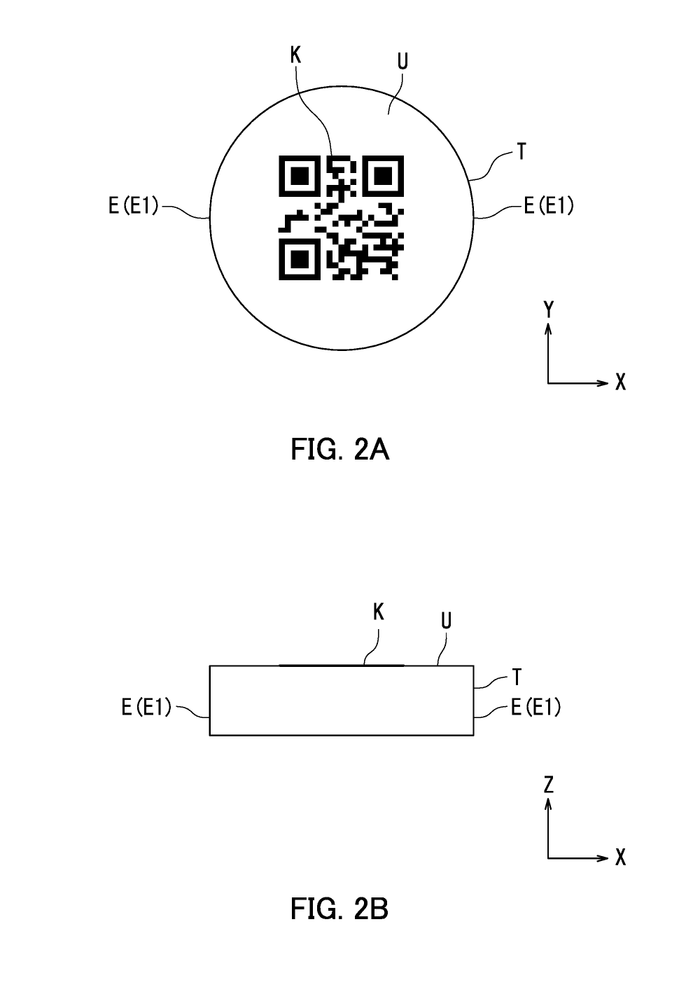

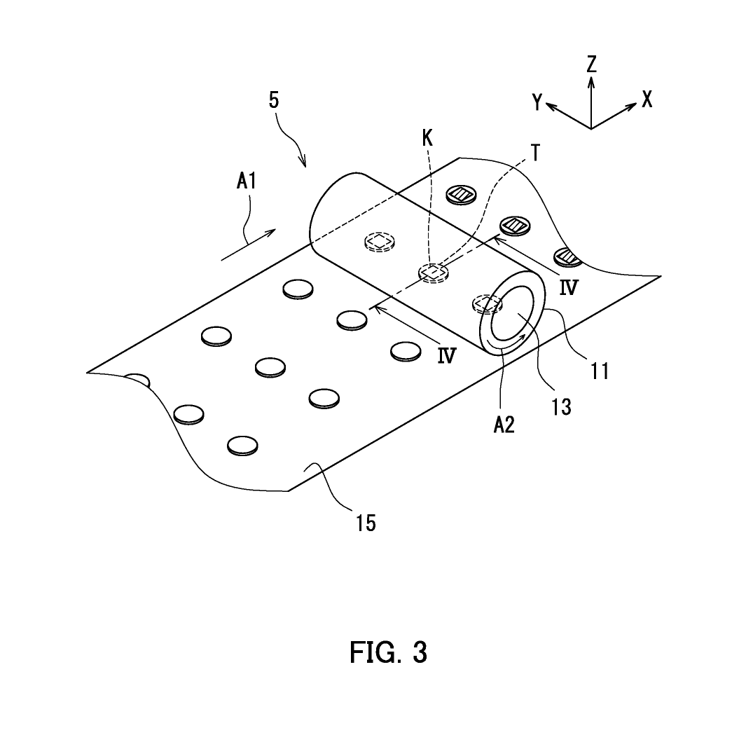

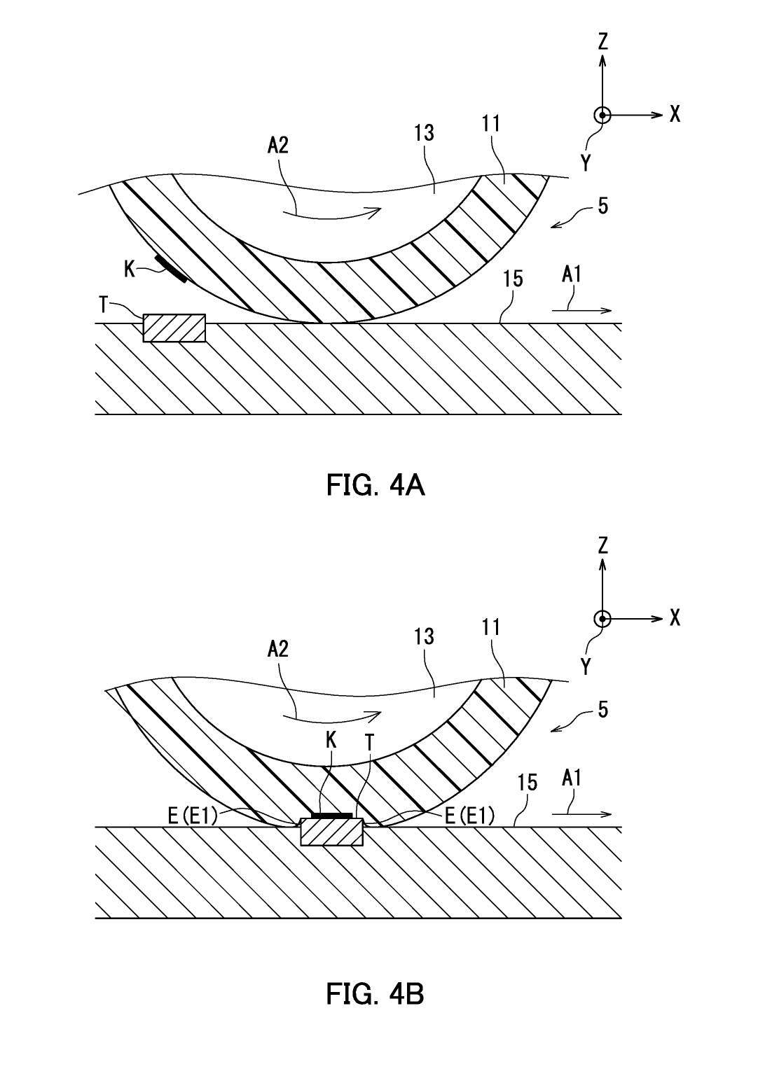

With reference to FIGS. 1-4, the basic principles of the printing apparatus 10 according to the embodiment of the invention will be described. FIG. 1 is a side view schematically showing the printing apparatus 10 according to the present embodiment. FIG. 2(a) is a top view schematically showing a tablet T with ink K printed thereon. FIG. 2(b) is a side view schematically showing the tablet T with the ink K printed thereon. FIG. 3 is a perspective view showing a mode of transferring the ink K to the tablet T by the printing apparatus 10. FIGS. 4(a) is 4(b) are cross-sectional views taken along line IV-IV of FIG. 3.

The printing apparatus 10 transfers the ink K to a to-be-printed object to thereby print the ink K on the to-be-printed object. In the present embodiment, the to-be-printed object is a tablet. The printing apparatus 10 includes: a printing plate 3 and a transfer roll 5. To the printing plate 3, the ink K is supplied. To the transfer roll 5, the ink K is transferred from the printing plate 3. The transfer roll 5 makes contact with part of a side surface of the tablet T in such a manner as to wrap around the tablet T. As a result, the ink K is transferred to the tablet T.

According to the present embodiment, the elastically deformed transfer roll 5 (a medium) makes contact with at least part of the side surface of the to-be-printed object (tablet T) in such a manner as to wrap around the to-be-printed object. Therefore, close adhesion of the transfer roll 5 to the to-be-printed object permits reliable transfer of the ink K to the to-be-printed object. This can consequently suppress blurring of the ink K printed on the to-be-printed object.

### [Conveyance and Arrangement]

With reference to FIG. 1, the conveyance of the tablet T and the arrangement of the printing plate 3, the transfer roll 5, and the tablet T will be described based on a three-dimensional coordinate system. A Z-axis extends along a vertical direction. An X-axis and a Y-axis are parallel to a horizontal plane. The printing apparatus 10 can further include a conveyance section 15.

The conveyance section 15 is, for example, a belt conveyer. The conveyance section 15 extends along the X-axis. Formed at the conveyance section 15 are a plurality of recessed parts 16 on each of which the tablet T is loaded. The plurality of recessed parts 16 are formed at predetermined intervals in an X-axis direction. The plurality of recessed parts 16 are also formed at predetermined intervals in a Y-axis direction. On each of the plurality of recessed parts 16 formed at the conveyance section 15, the tablet T is loaded. The conveyance section 15 conveys the tablets T in a conveyance direction Al along the X-axis.

With reference to FIGS. 2(a) and 2(b), the tablet T on which the ink K has been printed by the printing apparatus 10 according to the present embodiment will be described. The tablet T has a discoidal shape in the present embodiment. The tablet T is, for example, an uncoated tablet (plain tablet). The tablet T has an upper surface U and a side surface E (El). Printed on the upper surface U of the tablet T by the printing apparatus 10 is the ink K indicating identification information corresponding to the tablet T. The identification information is, for example, a matrix type two-dimensional code. The matrix type two-dimensional code is, for example, a QR code (registered trademark).

Returning to FIG. 1 again, the transfer roll 5 and the printing plate 3 will be described. The transfer roll 5 has a cylindrical shape in the present embodiment. The transfer roll 5 rotates around a cylindrical shaft (axial line) in a direction of arrow A2. The cylindrical shaft extends along the Y-axis. The printing plate 3 has a cylindrical shape in the present embodiment. The printing plate 3 rotates around a cylindrical shaft (axial line) in a direction of arrow A3. The cylindrical shaft extends along the Y-axis.

[Printing plate]

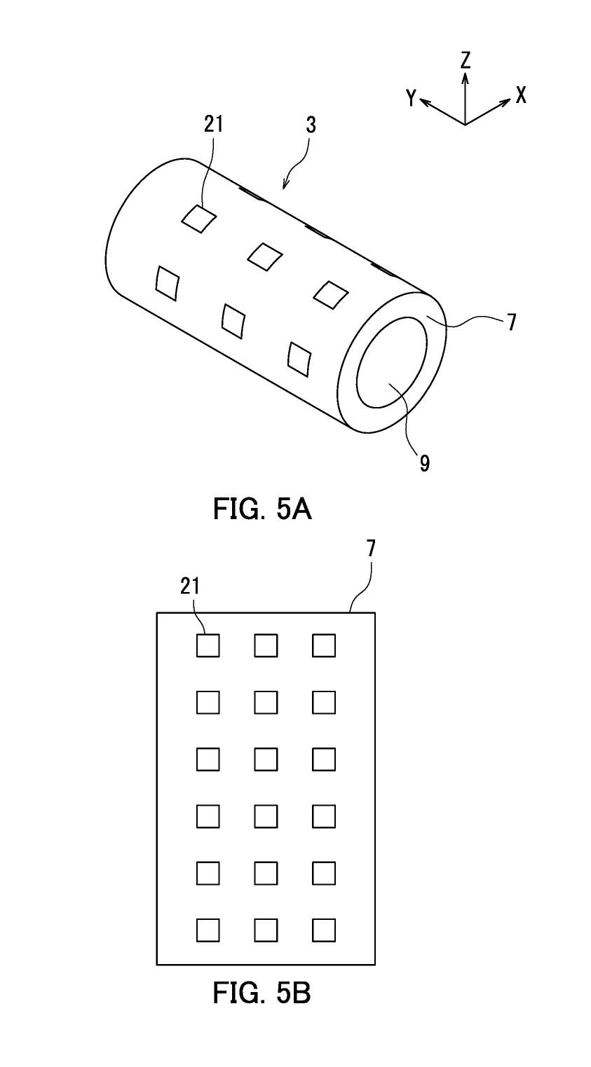

Details of the printing plate 3 will be described with reference to FIGS. 1 and 5. FIG. 5(a) is a perspective view showing the printing plate 3. FIG. 5(b) is a development view of a plate 7. The printing plate 3 includes the plate 7 and a plate cylinder 9. The plate 7 and the plate cylinder 9 are formed of, for example, metal. The metal is, for example, aluminum or iron. The plate cylinder 9 has a cylindrical shape. The plate 7 is attached to a circumferential surface of the plate cylinder 9. Formed on the plate 7 is a pattern 21 of the identification information (for example, the QR code (registered trademark)) corresponding to the tablet T. The pattern 21 is a portion of the plate 7 to which the ink K adheres. In the present embodiment, the plate 7 is a recessed plate, and thus the pattern 21 is a recessed part (for example, a groove). Therefore, the printing apparatus 10 executes gravure offset printing.

To a circumferential surface of the plate 7 of the printing plate 3 in rotation, the ink K is supplied from an ink supply section (not shown). As a result, the ink K adheres to (is filled in) the pattern 21.

### [Transfer Roll]

Details of the transfer roll 5 will be described with reference to FIGS. 1-4. The transfer roll 5 has a blanket 11 and a core 13. The core 13 has a cylindrical shape. The core 13 is formed of, for example, metal. The metal is, for example, aluminum or iron. The blanket 11 is attached to a circumferential surface of the core 13. The blanket 11 is an elastic body. The elastic body is, for example, rubber. The rubber is, for example, silicone rubber. A thickness of the blanket 11 is at least 10 mm and no greater than 20 mm, preferably at least 12.5 mm and no greater than 20 mm, and more preferably at least 15 mm and no greater than 20 mm. Rubber shore hardness of the blanket 11 is at least 15 and no greater than 55, preferably at least 15 and no greater than 50, and more preferably at least 15 and no greater than 45.

The transfer of the ink K from the printing plate 3 to the transfer roll 5 will be described. To the blanket 11 of the transfer roll 5 in rotation, the ink K adhering to the pattern 21 of the plate 7 is transferred from the printing plate 3 in rotation. A diameter of the transfer roll 5 is, for example, almost equal to a diameter of the printing plate 3. Moreover, an angular speed upon the rotation of the transfer roll 5 is, for example, almost equal to an angular speed upon the rotation of the printing plate 3.

Next, with reference to FIGS. 3 and 4, a mechanism of transferring the ink K from the blanket 11 to the tablet T will be described in detail. As shown in FIG. 4(a), the transfer roll 5 rotates in the direction of arrow A2. On the other hand, the tablet T is conveyed towards the transfer roll 5. Here, regardless of whether or not the tablet T is present, the blanket 11 is in contact with the conveyance section 15, and part of the blanket 11 is elastically deformed.

Then as shown in FIG. 4(b), upon conveyance of the tablet T to a region where the blanket 11 and the conveyance section 15 are in contact with each other, the tablet T is sandwiched between the blanket 11 and the conveyance section 15. Since the blanket 11 is being pressed against the tablet T, the blanket 11 is elastically deformed to cover the tablet T in such a manner as to wrap it around and makes contact with part of the side surface E (El) of the tablet T. At this point, a dimension of the elastically deformed region of the blanket 11 is larger than a dimension of the tablet T. Moreover, lengths of the elastically deformed region in the X-axis and Y-axis directions are larger than lengths of the tablet T in the X-axis and Y-axis directions. Since the tablet T is covered with the blanket 11 in such a manner as to be wrapped around thereby and the blanket 11 makes contact with part of the side surface E (El) of the tablet T, the ink K is transferred from the blanket 11 to the upper surface U of the tablet T. Further, since part of the side surface E (El) of the tablet T is covered, the ink K may also be transferred to part of the side surface E (El) of the tablet T.

The ink K is edible ink. For example, the ink K contains a chemical agent. In order to avoid any influence on positive effect of the tablet T, it is preferable that the ink K do not contain any natural material.

As described above with reference to FIGS. 1-4, according to the present embodiment, the identification information can easily be printed on the to-be-printed object (tablet T) via the transfer roll 5 (medium). The user can read the identification information printed on the to-be-printed object with an identification information reading terminal (for example, mobile phone) to thereby obtain information corresponding to the to-be-printed object. For example, the user reads the identification information with the mobile phone, whereby an address of a home page corresponding to the tablet T is displayed on the mobile phone. Therefore, the user can easily connect to the home page corresponding to the tablet T without inputting the displayed address of the home page. Alternatively, the user can read the identification information with the mobile phone to thereby display an expiring date of the tablet T on the mobile phone.

Moreover, the identification information printed on the to-be-printed object is the matrix type two-dimensional code. Therefore, compared to a one-dimensional code (for example, a bar code), more information can be encoded. As a result, for example, an address of a home page with a large amount of information can be encoded.

A thickness of the blanket 11 is at least 10 mm and no greater than 20 mm, which is larger than that of a conventional blanket, thus permitting contact with the to-be-printed object in such a manner as to wrap it around upon printing of the ink K on the to-be-printed object. As a result, close adhesion of the blanket 11 to the tablet T permits reliable transfer of the ink K, which can therefore suppress the blurring of the ink K.

The rubber Shore hardness of the blanket 11 is at least 15 and no greater than 55. The rubber Shore hardness of the blanket 11 is relatively soft, which therefore suppresses fracture of the tablet T upon the printing of the ink K on the tablet T.

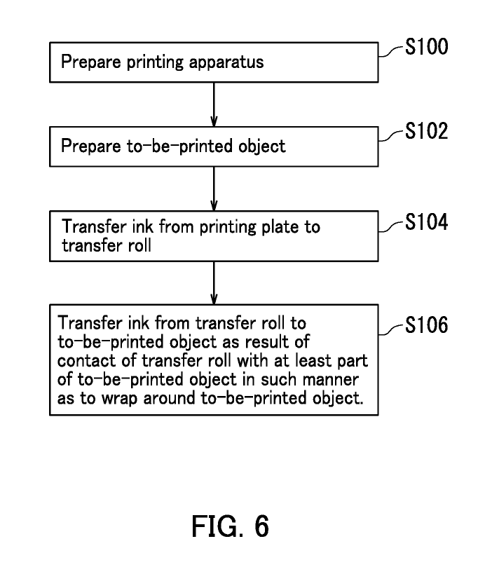

With reference to FIGS. 1 and 6, the printing method according to the embodiment of the invention will be described. FIG. 6 is a flowchart showing the printing method according to the embodiment of the invention. With the printing method of the present embodiment, as shown in FIG. 6, steps S100 to S106 are performed whereby the ink K is printed on the to-be-printed object (tablet T).

Step S100: The printing apparatus 10 including the printing plate 3 and the transfer roll 5 is prepared.

Step S102: The tablet T is prepared.

Step S104: The ink K is transferred from the printing plate 3 to the transfer roll 5.

Step S106: The transfer roll 5 makes contact with at least part of the side surface of the tablet T in such a manner as to wrap around the tablet T, whereby the ink K indicating the identification information corresponding to the tablet T is transferred from the transfer roll 5 to the tablet T.

As described above with reference to FIGS. 1-6, with the tablet printing method according to the embodiment of the invention, upon the transfer of the ink K indicating the identification information corresponding to the tablet T, the transfer roll 5 makes contact with at least part of the side surface of the tablet T in such a manner as to wrap around th tablet T. As a result, close adhesion of the transfer roll 5 to the tablet T permits reliable transfer of the ink K, which can therefore suppress the blurring of the ink K.

The invention is not limited to the embodiment described above, and within a range not departing from the spirts of the invention, it can be carried out in various modes, and, for example, the following modifications can also be made.
(1) The identification information printed on the to-be-printed object described with reference to FIGS. 1-6 is the QR code (registered trademark), but the identification information is not limited to the QR code (registered trademark). The identification information may be, for example, a matrix type two-dimensional code such as a CP code or a veri code. Alternatively, it may be a one-dimensional code such as a bar code.
(2) The tablet T described with reference to FIGS. 1-6 is an uncoated tablet, but the tablet T is not limited to the uncoated tablet. The tablet T may be, for example, a sugar-coated tablet or a film-coated tablet.
(3) The tablet T described with reference to FIGS. 1-6 has a discoidal shape, but the shape of the tablet T is not limited to the discoidal shape. For example, the tablet T may have a shape with a gently curved top surface. Alternatively, the to-be-printed object may be an encapsulated tablet. A more sharply curved printing surface results in softer rubber Shore hardness of the blanket 11, and it is preferable that the thickness of the blanket 11 be larger. In a case where the tablet T has a discoidal shape, the rubber Shore hardness is, for example, at least 30 and no greater than 40, and the thickness of the blanket 11 is 10 mm. On the other hand, in a case where the to-be-printed object is an encapsulated tablet, the rubber Shore hardness is, for example, at least 20 and no greater than 30, and the thickness of the blanket 11 is 15 mm.
(4) The printing apparatus described with reference to FIGS. 1-6, as a result of loading the to-be-printed object on the recessed part formed at the conveyance section 15, conveys the to-be-printed object, but the invention is not limited to this. For example, the to-be-printed object may be supported by a supporting member provided at the conveyance section 15 and the conveyance section 15 may convey the supporting member to thereby convey the to-be-printed object. In this case, upon the conveyance of the to-be-printed object, the blanket 11 is elastically deformed as a result of contact between the tablet T and the supporting member. As a result, the tablet T is covered with the blanket 11 in such a manner as to be wrapped around thereby, and thus the ink K is transferred from the blanket 11 to the top surface of the tablet T.
(5) The to-be-printed object on which the printing apparatus described with reference to FIGS. 1-6 performs printing is the tablet T, but the to-be-printed object is not limited to the tablet T. The to-be-printed object may be, for example, a cosmetic bottle or a golf ball. Since the to-be-printed object is covered with the blanket 11 in such a manner as to be wrapped around thereby, favorable printing can be performed even on the to-be-printed object having a curved printing surface.
(6) In the printing apparatus described with reference to FIGS. 1-6, upon the transfer of the ink to the to-be-printed object, the transfer roll 5 is in contact with the conveyance section 15, but the invention is not limited to this. For example, while the transfer roll 5 makes contact with the conveyed to-be-printed object, the transfer roller 5 does not have to make contact with the conveyance section 15. With reference to FIGS. 1, 6, 7, and 8, the printing apparatus 10 according to the embodiment of the invention will be described. Configuration of the printing apparatus 10 is equal to configuration of the printing apparatus 10 described with reference to FIG. 1. Moreover, a printing method executed by the printing apparatus 10 is equal to the printing method described with reference to FIG. 6. In the present embodiment, the ink K is transferred not to the discoidal to-be-printed object but to a columnar to-be-printed object 17 or a bottle-like, to-be-printed object 17.

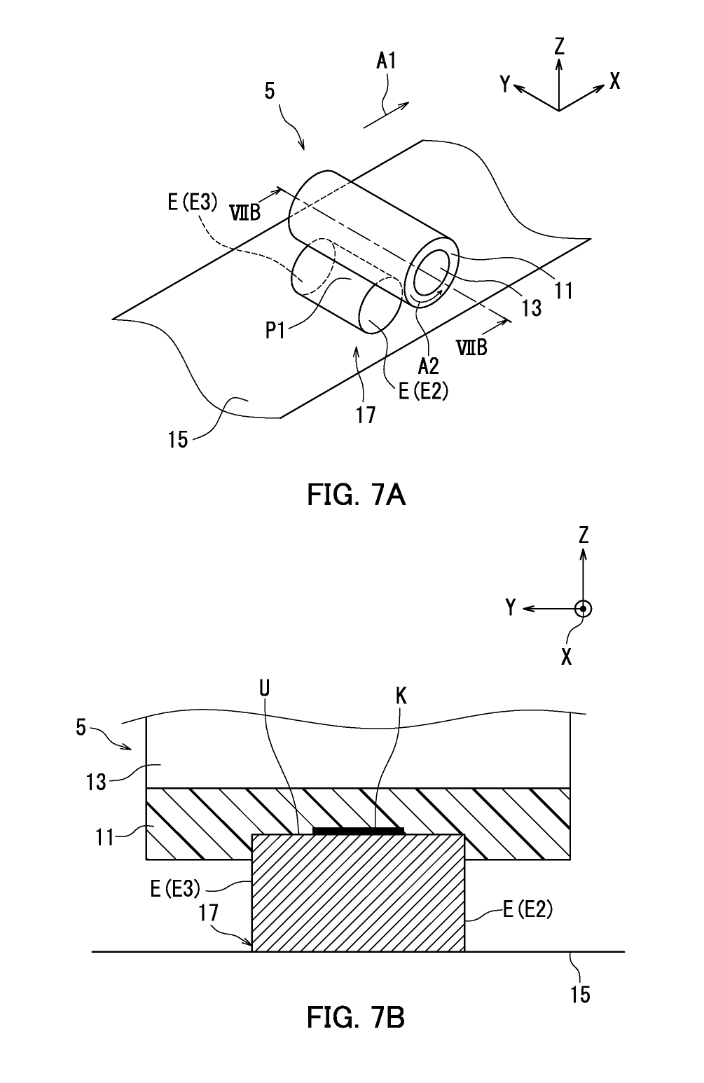

First, with reference to FIGS. 7, an example in which the ink K is transferred to the columnar to-be-printed object 17 will be described. FIG. 7(a) is a perspective view showing a mechanism of transferring the ink K to the columnar to-be-printed object 17 in the printing apparatus of the present embodiment. FIG. 7(b) is a schematic cross-sectional view taken along line VIIB-VIIB of FIG. 7(a).

The transfer roll 5 is arranged in a manner such that a side surface E2 and a side surface E3 of the to-be-printed object 17 are located between one end edge and another end edge of the transfer roll 5. Moreover, for example, a pattern of identification information (for example, a QR code (registered trademark)) corresponding to the to-be-printed object 17 is formed on the plate 7.

Upon forward movement of the to-be-printed object 17 along the conveyance direction A1, the to-be-printed object 17 is sandwiched between the blanket 11 and the conveyance section 15. Since the blanket 11 is being pressed against an upper surface U of the to-be-printed object 17, the blanket 11 is elastically deformed to cover part of the side surface E2 and part of the side surface E3 of the to-be-printed object 17 in such a manner as to wrap around the to-be-printed object. To the upper surface U of the to-be-printed object 17, the ink K is transferred. Here, the blanket 11 is in contact with the to-be-printed object 17 but not in contact with the conveyance section 15.

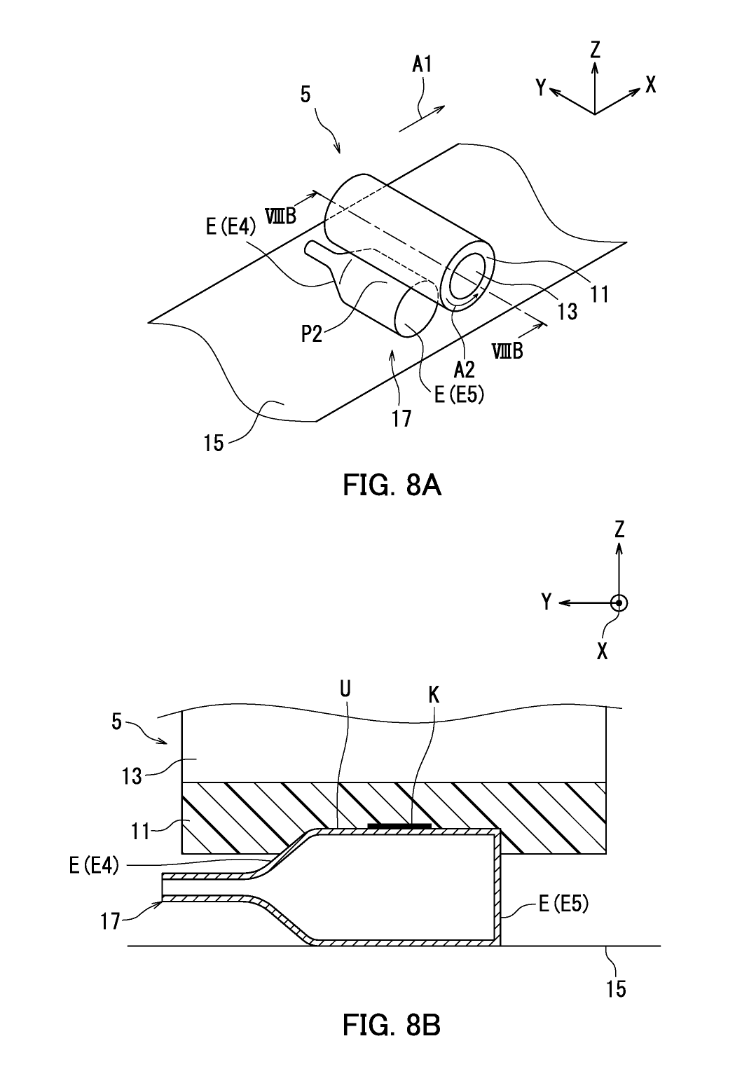

Next, with reference to FIGS. 8, an example in which the ink K is transferred to the bottle-like, to-be-printed object 17 will be described. FIG. 8(a) is a perspective view showing a mechanism of transferring the ink K to the bottle-like, to-be-printed object in the printing apparatus of the present embodiment. FIG. 8(b) is a schematic cross-sectional view taken along line VIIIB-VIIIB of FIG. 8(a).

The transfer roll 5 is arranged in a manner such that a side surface E4 and a side surface E5 of the to-be-printed object 17 are located between one end edge and another end edge of the transfer roll 5. Moreover, for example, a pattern of identification information (for example, a QR code (registered trademark)) corresponding to the to-be-printed object 17 is formed on the plate 7.

Upon forward movement of the to-be-printed object 17 in the conveyance direction A1, the to-be-printed object 17 is sandwiched between the blanket 11 and the conveyance section 15. Since the blanket 11 is being pressed against an upper surface U of the to-be-printed object 17, the blanket 11 is elastically deformed to cover part of the side surface E4 and part of the side surface E5 of the to-be-printed object 17 in such a manner as to wrap around the to-be-printed object. To the upper surface U of the to-be-printed object 17, the ink K is transferred. Here, the blanket 11 is in contact with the to-be-printed object 17 but not in contact with the conveyance section 15.

According to the present embodiment, the ink K can be transferred to the upper surface U of the columnar or bottle-like, to-be-printed object 17 via the transfer roll 5 (medium). The elastically deformed transfer roll 5 makes contact with at least part of the side surfaces of the to-be-printed object in such a manner as to wrap around the to-be-printed object. Therefore, close adhesion of the transfer roll 5 to the to-be-printed object 17 permits reliable transfer of the ink K to the to-be-printed object 17. This can consequently suppress the blurring of the ink K printed on the to-be-printed object 17.
(7) The printing apparatus described with reference to FIGS. 1-8 transfers the ink K to the upper surface U of the to-be-printed object, but the invention is not limited to this. The printing apparatus may transfer the ink K to the side surface E of the to-be-printed object. Alternatively, the printing apparatus may transfer the ink K to part of the upper surface U and the side surface E of the to-be-printed object.
(8) In the printing apparatus described with reference to FIGS. 1-8, the conveyance section 15 has a belt-like shape, but the invention is not limited to this. The conveyance section 15 may have a drum-like shape. In a case where the conveyance section 15 has a drum-like shape, it is preferable that the printing apparatus be provided with absorption means for holding the to-be-printed object so as to avoid dropping of the to-be-printed object from the conveyance section 15.

### INDUSTRIAL APPLICABILITY

With a printing method of the invention, identification information can favorably be printed on a to-be-printed object.

### REFERENCE SIGNS LIST

3 Printing plate
5 Transfer roll
7 Plate
9 Plate cylinder
10 Printing apparatus
11 Blanket
13 Core
15 Conveyance section
17 To-be-printed object
21 Pattern
T Tablet
K Ink
U Upper surface
E Side surface

1. A printing method comprising:
preparing a printing apparatus including a printing plate and a transfer roll;
preparing a to-be-printed object;
transferring ink indicating identification information corresponding to the to-be-printed object from the printing plate to the transfer roll; and
transferring the ink from the transfer roll to the to-be-printed object as a result of contact of the transfer roll with at least part of a side surface of the to-be-printed object in such a manner as to wrap around the to-be-printed object.

2. The printing method according to claim 1, wherein
the printing apparatus further includes a conveyance section conveying the to-be-printed object, and
in the transferring the ink, the transfer roll makes contact with the conveyance section.

3. The printing method according to claim 1, wherein
the identification information is a matrix type two-dimensional code.

4. The printing method according to claim 1, wherein
the transfer roll has a blanket and a core, and
a thickness of the blanket is at least 10 mm and no greater than 20 mm.

5. The printing method according to claim 4, wherein
rubber Shore hardness of the blanket is at least 15 and no greater than 55.

6. The printing method according to claim 1, wherein
the to-be-printed object is a tablet.

7. A printing apparatus comprising:
a printing plate; and
a transfer roll transferring, to a to-be-printed object, ink transferred from the printing plate, wherein
a pattern based on identification information indicating information corresponding to the to-be-printed object is formed on the printing plate,
upon the transfer of the ink to the to-be-printed object, the transfer roll makes contact with at least part of a side surface of the to-be-printed object in such a manner as to wrap around the to-be-printed object.

8. The printing apparatus according to claim 7, further comprising
a conveyance section conveying the to-be-printed object, wherein
in the transferring the ink, the transfer roll makes contact with the conveyance section.

9. The printing apparatus according to claim 7, wherein
the identification information is a matrix type two-dimensional code.

10. The printing apparatus according to claim 7, wherein
the transfer roll has a blanket and a core, and
a thickness of the blanket is at least 10 mm and no greater than 20 mm.

11. The printing apparatus according to claim 10, wherein
rubber Shore hardness of the blanket is at least 15 and no greater than 55.

12. The printing apparatus according to claim 7, wherein
the to-be-printed object is a tablet.

13. The printing method according to claim 1, wherein
in the transferring the ink, the ink is transferred from the transfer roll to the to-be-printed object as a result of contact of the transfer roll with at least part of the side surface of the to-be-printed object in such a manner as to wrap around the to-be-printed object while conveying the to-be-printed object in a conveyance direction,
the to-be-printed object has:
an upper surface;
a front side surface being located in front with respect to the conveyance direction; and
a back side surface being located at back with respect to the conveyance direction, and
the transferring the ink includes:
causing the transfer roll to be in contact with at least part of the upper surface and at least part of the front side surface;
causing the transfer roll to be in contact with the upper surface, at least part of the front side surface, and at least part of the back side surface to attach the ink to the upper surface of the to-be-printed object; and
separating the transfer roll from the front side surface and causing the transfer roller to be in contact with at least part of the upper surface and at least part of the back side surface.

14. The printing apparatus according to claim 7, wherein
upon the transfer of the ink to the to-be-printed object, the transfer roll makes contact with at least part of the side surface of the to-be-printed object in such a manner as to wrap around the to-be-printed object while conveying the to-be-printed object in a conveyance direction,
the to-be-printed object has:
an upper surface;
a front side surface being located in front with respect to the conveyance direction; and
a back side surface being located at back with respect to the conveyance direction, and
upon the transfer of the ink,
the transfer roll makes contact with at least part of the upper surface and at least part of the front side surface,
then the transfer roll makes contact with the upper surface, at least part of the front side surface, and at least part of the back side surface to attach the ink to the upper surface of the to-be-printed object, and
then the transfer roll separates from the front side surface and makes contact with at least part of the upper surface and at least part of the back side surface.
